(19) United States
(12) Patent Application Publication
(10) Pub. No.: US 2017/0241693 A1
(43) Pub. Date: Aug. 24, 2017

(54) VENDING MACHINE

(71) Applicant: SANDEN HOLDINGS CORPORATION, Isesaki-shi, Gunma (JP)

(72) Inventors: Mototaka TAJIKA, Isesaki-shi, Gunma (JP); Yuuki YANAGISAWA, Isesaki-shi, Gunma (JP)

(21) Appl. No.: 15/515,100

(22) PCT Filed: Mar. 17, 2015
(86) PCT No.: PCT/JP2015/057800

§ 371 Date: Mar. 28, 2017

(30) Foreign Application Priority Data
Sep. 29, 2014 (JP) 2014-198087

(51) Int. Cl. F25D 11/02; F25D 31/00; G07F 9/10; F25B 47/02

(52) U.S. Cl. CPC F25D 11/022; F25B 47/022; F25D 31/007; G07F 9/105; F25D 2600/02

(57) ABSTRACT

The present invention provides a vending machine having a compartment whose preset internal temperature is lower than those of compartments in conventional commonly-used beverage vending machines, and yet being capable of limiting energy required for cooling the interiors of its compartments. A vending machine 1 for cooling and dispensing products has at least three compartments (right compartment 4, center compartment 5, and left compartment 6) which are defined by heat-insulated walls (partition walls) 3 and which are for cooling products contained therein. The right, center and left compartments 4, 5, 6 are disposed side by side in a row. The preset internal temperature for the center compartment 5, which lies between the right and left compartments 4, 6, is lower than those for the right and left compartments 4, 6.

### TECHNICAL FIELD

The present invention relates to a vending machine for cooling and dispensing products.

### BACKGROUND ART

Known examples of vending machines for cooling and dispensing products include a frozen beverage vending machine as disclosed in Patent Document 1. This frozen beverage vending machine cools and dispenses beverages each of which is packaged in a container such as a PET bottle (referred to as “bottled beverages” below). In this frozen drink vending machine, the internal product storage is partitioned into three compartments by partition walls. Among the three compartments, the left compartment functions as a frozen beverage compartment, and the center and right compartments function as cold beverage compartments. The frozen beverage compartment is maintained at a preset temperature (−25° C., for example) that allows the freezing of bottled beverages. The cold beverage compartment is maintained at a preset temperature (5° C., for example) that allows the cooling of bottled beverages at a temperature suitable for drinking. When a product selection button is pressed, the frozen drink vending machine delivers and dispenses a bottled beverage corresponding to the button.

### REFERENCE DOCUMENT LIST

### Patent Document

Patent Document 1: JP 2006-48325 A

### SUMMARY OF THE INVENTION

### Problems to be Solved by the Invention

The frozen beverage vending machine has a compartment whose preset internal temperature is lower than those of compartments in conventional commonly-used beverage vending machines (frozen beverage compartment). Thus, such frozen beverage vending machine requires more energy (power consumption) to cool the interiors of the compartments than conventional commonly-used beverage vending machines. Therefore, it is desirable to limit energy required for cooling the interiors of the compartments in such frozen beverage vending machines.

The present invention has been made to solve the above problem, and has an object to provide a vending machine having a compartment whose preset internal temperature is lower than those of compartments in conventional commonly-used beverage vending machines, and yet being capable of limiting energy required for cooling the interiors of its compartments.

### Means for Solving the Problems

According to an aspect of the present invention, a vending machine has at least three compartments which are defined by partition walls and which are for cooling products contained therein. In this vending machine, the at least three compartments are disposed side by side in a row. The at least three compartments include a first compartment and a second compartment, and a remaining compartment which is other than and disposed between the first and second compartments in which a preset internal temperature for the remaining compartment is lower than preset internal temperatures for the first and second compartments.

### Effects of the Invention

In such vending machine, the remaining compartment, whose internal temperature is set lower, lies between the first and second compartments. The first and second compartments reduce heat entering the remaining compartment from the outside. With this configuration, even though having a compartment whose preset internal temperature is lower than those of compartments in conventional commonly-used beverage vending machines, the vending machine is yet capable of limiting energy (power consumption) required for cooling the interiors of the compartments.

### BRIEF DESCRIPTION OF THE DRAWINGS

FIG. 1 shows a schematic configuration diagram of an embodiment of a vending machine to which the present invention is applied.

FIG. 2 shows a circuit configuration diagram of a refrigeration cycle system of the vending machine.

FIG. 3 shows the state of the refrigeration cycle system (refrigerant circulation route) while cooling the interior of a left compartment of the vending machine.

FIG. 4 shows the state of the refrigeration cycle system (refrigerant circulation route) while cooling the interior of a center compartment of the vending machine.

FIG. 5 shows the state of the refrigeration cycle system (refrigerant circulation route) while cooling the interior of a right compartment of the vending machine is cooled.

FIG. 6 shows the state of the refrigeration cycle system (refrigerant circulation route) while cooling the interior of the left compartment and defrosting an in-compartment heat exchanger disposed in the center compartment.

FIG. 7 shows the state of the refrigeration cycle system (refrigerant circulation route) while cooling the interior of the right compartment and defrosting the in-compartment heat exchanger disposed in the center compartment.

FIG. 8 shows the circuit configuration diagram of another refrigeration cycle system of the vending machine.

### MODE FOR CARRYING OUT THE INVENTION

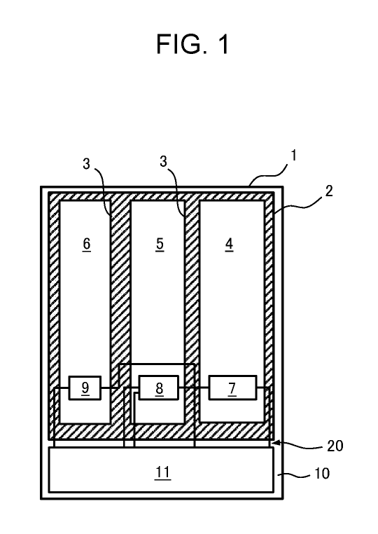

An embodiment of the present invention will be described below with reference to the accompanying drawings. FIG. 1 shows a schematic configuration of an embodiment of a vending machine to which the present invention is applied. The vending machine 1 according to the embodiment is configured to cool and dispense bottled beverages. The vending machine 1 internally includes a heat-insulated product storage 2. The product storage 2 is partitioned into three compartments (a right compartment 4, a center compartment 5, and a left compartment 6) by heat-insulated walls (partition walls) 3. The three compartments 4 to 6 are disposed side by side in a row in the width direction of the vending machine 1.

Each of the compartments 4 to 6 is provided with a product storage device (not shown). The product storage device is capable of containing a large number of bottled beverages and has a product delivery mechanism. The vending machine 1 is configured such that when, for example, any of product selection buttons (not shown) is pressed, the corresponding one of the product storage devices delivers a product (bottled beverage) corresponding to the pressed button to a product outlet (not shown). In this embodiment, the right compartment 4 has the largest capacity among the three compartments 4 to 6.

The right compartment 4 is provided with a first cooling unit 7. The center compartment 5 is provided with a second cooling unit 8. The left compartment 6 is provided with a third cooling unit 9. A condensing unit 11 is disposed in a machine compartment 10 located below the product storage 2. The first to third cooling units 7 to 9 are connected with the condensing unit 11 through a refrigerant pipe 20 so as to constitute a refrigeration cycle system 30. The refrigeration cycle system 30 is capable of individually cool the interiors of the right, center and left compartments 4, 5, 6 by circulating refrigerant through the refrigeration cycle system 30.

In this embodiment, each of the right compartment 4 and the left compartment 6 is cooled by the refrigeration cycle system 30 to function as a refrigerator compartment. The center compartment 5 is cooled by the refrigeration cycle system 30 to function as a supercooling compartment. To be specific, each of the right and left compartments 4, 6 is configured to contain bottled beverages at a cool temperature suitable for drinking (i.e., configured to maintain bottled beverages under refrigeration). Meanwhile, the center compartment 5 is configured to contain bottled beverages in a supercooled state. Thus, the refrigeration cycle system 30 maintains the temperature (internal temperature) in each of the right and left compartments 4, 6 at a first preset temperature that allows the cooling of bottled beverages at a temperature suitable for drinking. The refrigeration cycle system 30 maintains the temperature (internal temperature) in the center compartment 5 at a second preset temperature that allows the cooling of bottled beverages in a supercooled state. The first preset temperature is higher than the freezing point of the bottled beverages, and may be around 5° C. (approximately 3° C. to 8° C.), for example. The second preset temperature is equal to or lower than the freezing point of the bottled beverages, and may be around −5° C. (approximately −2° C. to −7° C.), for example.

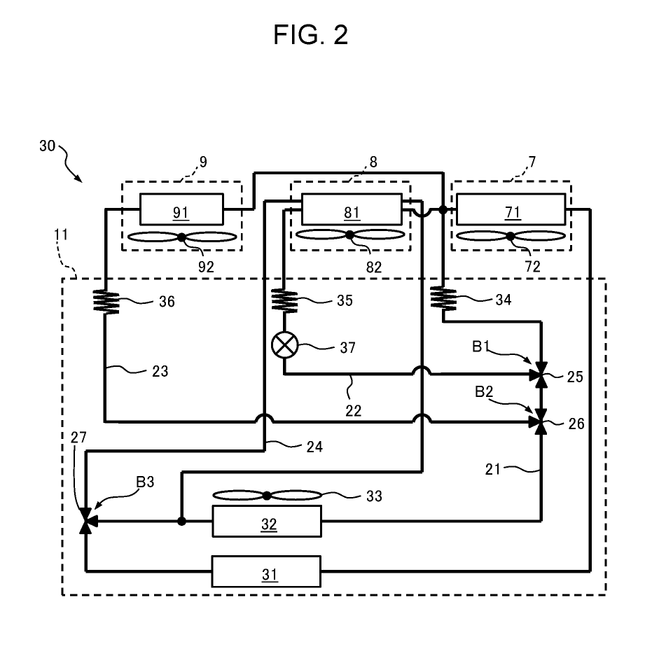

FIG. 2 shows the circuit configuration of the refrigeration cycle system 30. As described above, the refrigeration cycle system 30 includes the first cooling unit 7 provided in the right compartment 4, the second cooling unit 8 provided in the center compartment 5, the third cooling unit 9 provided in the left compartment 6, the condensing unit 11 disposed in the machine compartment 10, and the refrigerant pipe 20 connecting the condensing unit 11 with the first to third cooling units 7 to 9. In the refrigeration cycle system 30, the interiors of the right, center and left compartments 4, 5, 6 are individually cooled by the refrigerant circulating through the refrigerant pipe 20 while selectively flowing through any or all of the first to third cooling units 7 to 9.

The first cooling unit 7 has a first evaporator (in-compartment heat exchanger) 71 and a first evaporator fan 72 for blowing air to the first evaporator 71. The second cooling unit 8 has a second evaporator (in-compartment heat exchanger) 81 and a second evaporator fan 82 for blowing air to the second evaporator 81. The third cooling unit 9 has a third evaporator (in-compartment heat exchanger) 91 and a third evaporator fan 92 for blowing air to the third evaporator 91. The evaporators 71, 81, 91 cool the interiors of the compartments 4 to 6 by exchanging heat between the refrigerant and interior air in the compartments 4 to 6, respectively.

The condensing unit 11 has a compressor 31, a gas cooler (external-to-compartment heat exchanger) 32, a gas cooler fan 33 for blowing air to the gas cooler 32, and an expansion mechanism (a first capillary tube 34, a second capillary tube 35, a third capillary tube 36, and an electronic expansion valve 37). The compressor 31 compresses the refrigerant (into high-temperature, high-pressure gaseous refrigerant). The gas cooler 32 cools the refrigerant (high-temperature, high-pressure gaseous refrigerant) discharged from the compressor 31 to ordinary temperature. The expansion mechanism expands the refrigerant cooled by the gas cooler 32 into low-temperature, low-pressure refrigerant. As the expansion mechanism for the center compartment 5, the second capillary tube 35 and the electronic expansion valve 37 are provided in this embodiment, but only either one of the second capillary tube 35 and the electronic expansion valve 37 may be provided instead. Though not shown, it is preferable to provide a so-called internal heat exchanger for exchanging heat between refrigerant before entering the compressor 31 and refrigerant having been discharged from the gas cooler 32.

The refrigerant pipe 20 includes first to fourth refrigerant flow channels 21 to 24. The first refrigerant flow channel 21 is for circulating the refrigerant by way of the compressor 31, the gas cooler 32, the first capillary tube 34, and the first evaporator 71 sequentially in this order. The refrigerant flowing through the first refrigerant flow channel 21 cools the interior of the right compartment 4.

The second refrigerant flow channel 22 is for circulating, by way of the second evaporator 81, the refrigerant having passed through the compressor 31 and the gas cooler 32. The refrigerant flowing through the second refrigerant flow channel 22 cools the interior of the center compartment 5. The second refrigerant flow channel 22, which branches off from the first refrigerant flow channel 21 at a point between the gas cooler 32 and the first capillary tube 34, is connected to the first refrigerant flow channel 21 at a point between the first capillary tube 34 and the first evaporator 71. The second refrigerant flow channel 22 extends by way of the electronic expansion valve 37, the second capillary tube 35, and the second evaporator 81. A first flow channel switching valve (electromagnetic three-way valve) 25 is provided at the branching point B1 where the second refrigerant flow channel 22 branches off from the first refrigerant flow channel 21. When turned off, the first flow channel switching valve 25 permits communication between the gas cooler 32 and the first capillary tube 34 through the first refrigerant flow channel 21 with respect to the branching point B1. When turned on, the first flow channel switching valve 25 permits communication between the second refrigerant flow channel 22 and the gas cooler 32 through the first refrigerant flow channel 21 with respect to the branching point B1.

The third refrigerant flow channel 23 is for circulating, by way of the third evaporator 91, the refrigerant having passed through the compressor 31 and the gas cooler 32. The refrigerant flowing through the third refrigerant flow channel 23 cools the interior of the left compartment 6. The third refrigerant flow channel 23, which branches off from the first refrigerant flow channel 21 at a point between the gas cooler 32 and the first capillary tube 34, is connected to the first refrigerant flow channel 21 at a point between the first capillary tube 34 and the first evaporator 71. The third refrigerant flow channel 23 extends by way of the third capillary tube 36 and the third evaporator 91. A second flow channel switching valve (electromagnetic three-way valve) 26 is provided at the branching point B2 where the third refrigerant flow channel 23 branches off from the first refrigerant flow channel 21. When turned off, the second flow channel switching valve 26 permits communication between the gas cooler 32 and the first capillary tube 34 through the first refrigerant flow channel 21 with respect to the branching point B2. When turned on, the second flow channel switching valve 26 permits communication between the third refrigerant flow channel 23 and the gas cooler 32 through the first refrigerant flow channel 21 with respect to the branching point B2.

The fourth refrigerant flow channel 24 is for circulating, by way of the second evaporator 81, the refrigerant discharged from the compressor 31 (i.e., high-temperature, high-pressure gaseous refrigerant before passing through the gas cooler 32). The fourth refrigerant flow channel 24 is used mainly for defrosting the second evaporator 81. The fourth refrigerant flow channel 24, which branches off from the first refrigerant flow channel 21 at a predetermined point between the compressor 31 and the gas cooler 32, is connected to the first refrigerant flow channel 21 at a point between the compressor 31 and the gas cooler 32 and closer to the gas cooler 32 than the predetermined point. The fourth refrigerant flow channel 24 extends by way of the second evaporator 81. A third flow channel switching valve (electromagnetic three-way valve) 27 is provided at the branching point B3 where the fourth refrigerant flow channel 24 branches off from the first refrigerant flow channel 21. When turned off, the third flow channel switching valve 27 permits communication between the compressor 31 and the gas cooler 32 through the first refrigerant flow channel 21 with respect to the branching point B3. When turned on, the third flow channel switching valve 27 permits communication between the fourth refrigerant flow channel 24 and the compressor 31 through the first refrigerant flow channel 21 with respect to the branching point B3.

The operation of the refrigeration cycle system 30 configured as above is controlled by a control device (not shown) of the vending machine 1. Specifically, from various sensors (not shown), the control device receives measurements such as the internal temperatures of the compartments 4 to 6, the temperatures at the refrigerant inlet and outlet of the gas cooler 32, the temperatures at the refrigerant inlet and outlet of the evaporators 71, 81, 91, and the outside air temperature. The control device controls the operation of the refrigeration cycle system 30 by appropriately controlling the first to third flow channel switching valves 25 to 27, the compressor 31, the gas cooler fan 33, the electronic expansion valve 37, and the first to third evaporator fans 72, 82, 92. How the operation of the refrigeration cycle system 30 is controlled by the control device will be specifically described below.

### (1) Start-Up Control

When starting up (including restarting) the vending machine 1, the control device reduces the internal temperatures of the right and left compartments 4, 6 to the first preset temperature, and the internal temperature of the center compartment 5 to the second preset temperature. Specifically, the control device controls the operation of the refrigeration cycle system 30 such that the internal temperatures of the right, center and left compartments 4, 5, 6 are reduced first to the first preset temperature, and the internal temperature of the center compartment 5 is then further reduced to the second preset temperature.

In this embodiment, the control device reduces the internal temperatures of the left compartment 6, the center compartment 5, and the right compartment 4 to the first preset temperature sequentially in this order. Note, however, that the present invention is not limited to this. The internal temperatures of the compartments may be reduced to the first preset temperature in any order set as appropriate.

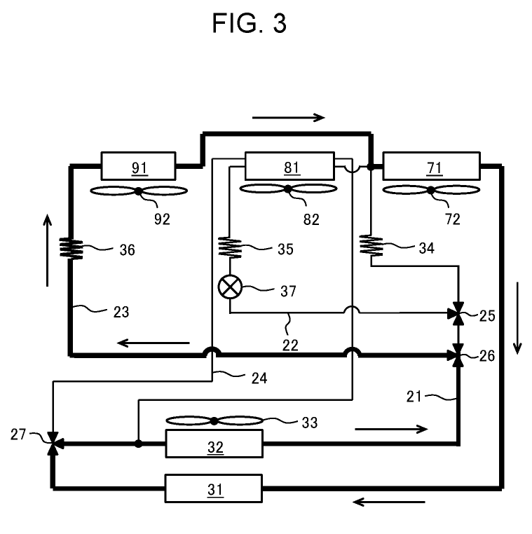

FIG. 3 shows the state of the refrigeration cycle system 30 (refrigerant circulation route) while cooling the interior of the left compartment 6. To cool the interior of the left compartment 6, the control device activates the compressor 31, the gas cooler fan 33, and the first and third evaporator fans 72, 92, and turns on the second flow channel switching valve 26. As a result, the refrigerant circulates by way of the compressor 31, the gas cooler 32, the third capillary tube 36, the third evaporator 91, and the first evaporator 71 sequentially in this order, as shown in FIG. 3. This reduces the internal temperature(s) of the left compartment 6 (and the right compartment 4).

When the internal temperature of the left compartment 6 has been reduced to the lower limit of the first preset temperature, the control device stops the third evaporator fan 92 and turns off the second flow channel switching valve 26. Accordingly, the cooling of the interior of the left compartment 6 at the start-up of the vending machine 1 is finished. Here, during the cooling of the interior of the left compartment 6, the first evaporator fan 72 is activated in addition to the third evaporator fan 92. This aims at preliminarily cooling the interior of the right compartment 4, which has a large capacity, so as to limit energy consumption (power consumption) during the cooling of the interior of the right compartment 4. However, during the cooling of the interior of the left compartment 6, the first evaporator fan 72 is not necessarily activated, so that only the interior of the left compartment 6 may be cooled.

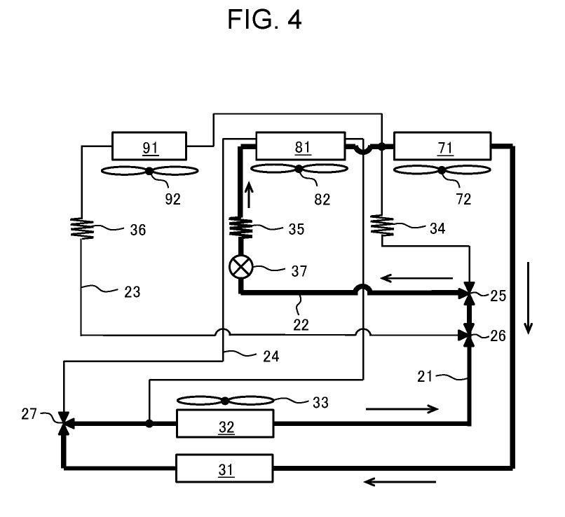

FIG. 4 shows the state of the refrigeration cycle system 30 (refrigerant circulation route) while cooling the interior of the center compartment 5. To cool the interior of the center compartment 5 after finishing cooling the interior of the left compartment 6, the control device activates the second evaporator fan 82, and turns on the first flow channel switching valve 25. The first evaporator fan 72 has been already activated at the start of cooling the interior of the left compartment 6. As a result, the refrigerant circulates by way of the compressor 31, the gas cooler 32, the electronic expansion valve 37, the second capillary tube 35, the second evaporator 81, and the first evaporator 71 sequentially in this order, as shown in FIG. 4. This reduces the internal temperature(s) of the center compartment 5 (and the right compartment 4).

When the internal temperature of the center compartment 5 has been reduced to the lower limit of the first preset temperature, the control device stops the second evaporator fan 82 and turns off the first flow channel switching valve 25. As described above, the first evaporator fan 72 remains activated during the cooling of the interior of the center compartment 5. Similarly to during the cooling of the interior of the left compartment 6, this aims at preliminarily cooling the interior of the right compartment 4, which has a large capacity, so as to reduce energy consumption during the cooling of the interior of the right compartment 4. However, during the cooling of the interior of the center compartment 5, the first evaporator fan 72 is not necessarily activated, so that only the interior of the center compartment 5 may be cooled.

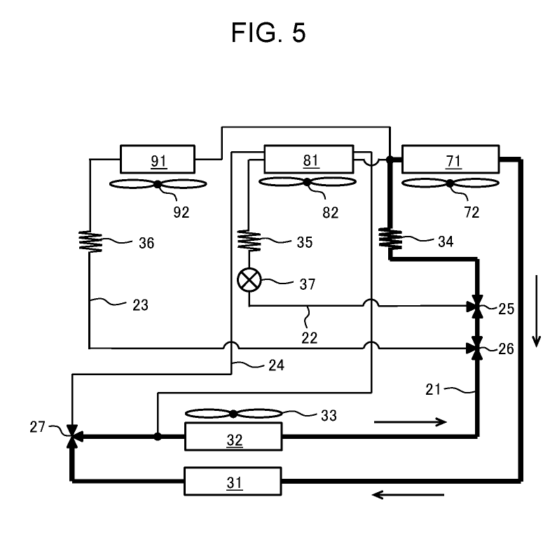

FIG. 5 shows the state of the refrigeration cycle system 30 (refrigerant circulation route) while cooling the interior of the right compartment 4. The refrigeration cycle system 30 starts cooling the interior of the right compartment 4 by finishing cooling the interior of the center compartment 5; in other words, the cooling of the interior of the right compartment 4 is started when the control device stops the second evaporator fan 82, and turns off the first flow channel switching valve 25. As a result, the refrigerant flows (circulates) through the first refrigerant flow channel 21 as shown in FIG. 5, and reduces the internal temperature of the right compartment 4.

When the internal temperature of the right compartment 4 has been reduced to the lower limit of the first preset temperature, the control device stops the first evaporator fan 72. Accordingly, the cooling of the interior of the right compartment 4 at the start-up of the vending machine 1 is finished.

After reducing the internal temperatures of the right, center and left compartments 4, 5, 6 to the first preset temperature as described above, the control device then reduces the internal temperature of the center compartment 5 to the second preset temperature. Specifically, the control device activates the second evaporator fan 82, and turns on the first flow channel switching valve 25. In addition, the control device adjusts (reduces) the extent of opening of the electronic expansion valve 37 so as to adjust the flow rate of the refrigerant. As a result, the refrigerant circulates by way of the compressor 31, the gas cooler 32, the electronic expansion valve 37, the second capillary tube 35, the second evaporator 81, and the first evaporator 71 sequentially in this order (see FIG. 4). This further reduces the internal temperature of the center compartment 5 from the first preset temperature.

When the internal temperature of the center compartment 5 has been reduced to the lower limit of the second preset temperature, the control device stops the second evaporator fan 82 and turns off the first flow channel switching valve 25. Accordingly, the cooling of the interior of the center compartment 5 at the start-up of the vending machine 1 is finished. The extent of opening (opening degree) of the electronic expansion valve 37 is maintained unchanged.

During the cooling of the interior of the center compartment 5, the first evaporator fan 72 may be additionally activated if, for example, the internal temperature of the right compartment 4 exceeds or is expected to exceed the upper limit of the first preset temperature. Accordingly, in addition to the internal temperature of the center compartment 5, the internal temperature of the right compartment 4 can be also reduced.

When the internal temperatures of the right and left compartments 4, 6 have been reduced to the first preset temperature, and the internal temperature of the center compartment 5 has been reduced to the second preset temperature; in other words, when the start-up of the vending machine 1 is completed, the control device stops the refrigeration cycle system 30 (switches the refrigeration cycle system 30 to standby) by stopping the compressor 31 and the gas cooler fan 33.

### (2) Normal Control

While the refrigeration cycle system 30 stops (is in standby), the control device monitors the internal temperatures of the compartments 4 to 6, and maintains the internal temperatures of the right and left compartments 4, 6 at the first preset temperature while maintaining the internal temperature of the center compartment 5 at the second preset temperature by causing the refrigeration cycle system 30 to operate as needed.

For example, when the internal temperature of the center compartment 5 exceeds the upper limit of the second preset temperature, the control device activates the compressor 31, the gas cooler fan 33, and the second evaporator fan 82 and turns on the first flow channel switching valve 25 so as to cool the interior of the center compartment 5 (see FIG. 4). Then, when the internal temperature of the center compartment 5 has been reduced to the lower limit of the second preset temperature, the control device stops the refrigeration cycle system 30 again (switches the refrigeration cycle system 30 back to standby). In this event, the control device may additionally activate the first evaporator fan 72 so as to also reduce the internal temperature of the right compartment 4.

For example, when the internal temperature of the left compartment 6 exceeds the upper limit of the first preset temperature, the control device activates the compressor 31, the gas cooler fan 33, and the third evaporator fan 92, and turns on the second flow channel switching valve 26 so as to cool the interior of the left compartment 6 (see FIG. 3). Then, when the internal temperature of the left compartment 6 has been reduced to the lower limit of the first preset temperature, the control device stops the refrigeration cycle system 30 again (switches the refrigeration cycle system 30 back to standby). In this event, the control device may additionally activate the first evaporator fan 72 so as to also reduce the internal temperature of the right compartment 4.

When, for example, the internal temperature of the right compartment 4 exceeds the upper limit of the first preset temperature, the control device activates the compressor 31, the gas cooler fan 33, and the first evaporator fan 72 so as to cool the interior of the right compartment 4 (see FIG. 5). Then, when the internal temperature of the right compartment 4 has been reduced to the lower limit of the first preset temperature, the control device stops the refrigeration cycle system 30 again (switches the refrigeration cycle system 30 back to standby).

### (3) Defrost Control

The control device performs defrost control for removing frost formed in the evaporators 71, 81, 91, periodically or as needed during the operation of the vending machine 1. In this embodiment, the control device first performs the defrost control for the first and third evaporators 71, 91 respectively disposed in the right and left compartment 4, 6, then performs the defrost control for the second evaporator 81 disposed in the center compartment 5.

### (3-1) Defrost Control for First Evaporator 71 and Third Evaporator 91

While the refrigeration cycle system 30 is in standby after a predetermined time has elapsed from the completion of the start-up of the vending machine 1 or from the last time the defrost control is performed, the control device performs the defrost control for the first and third evaporators 71, 91. Specifically, the control device defrosts the first and third evaporators 71, 91 by activating the first and third evaporator fans 72, 92. The compressor 31, the gas cooler fan 33, and the second evaporator fan 82 are kept stopped. In other words, the control device removes frost formed in the first and third evaporators 71, 91 respectively disposed in the right and left compartments 4, 6, whose internal temperatures are higher than 0° C., by blowing in-compartment air to the first and third evaporators 71, 91.

After that, when a first defrost time has elapsed from the activation of the first and third evaporator fans 72, 92, the control device stops the third evaporator fan 92. Then, when a second defrost time (≧the first defrost time) has elapsed from the activation of the first and third evaporator fans 72, 92, the control device stops the first evaporator fan 72. Accordingly, the defrosting of the first and third evaporators 71, 91 respectively disposed in the right and left compartments 4, 6 is finished. The first defrost time may be set as appropriate in accordance with the size of the third evaporator 91 (in the left compartment 6), and the like. The second defrost time may be set as appropriate in accordance with the size of the first evaporator 71 (in the right compartment 4), and the like.

### (3-2) Defrost Control for Second Evaporator 81

As described above, in this embodiment, the control device starts defrosting the first and third evaporators 71, 91 simultaneously. After the defrosting of the first evaporator 71 is finished, the internal temperature of the right compartment 4 becomes higher. After the defrosting of the third evaporator 91 is finished, the internal temperature of the left compartment 6 becomes higher. Thus, it is necessary to cool the interior of the right compartment 4 after finishing defrosting the first evaporator 71. Also, it is necessary to cool the interior of the left compartment 6 after finishing defrosting the third evaporator 91. Thus, after finishing defrosting the first and third evaporators 71, 91, the control device defrosts the second evaporator 81 disposed in the center compartment 5 while cooling the interior of the right compartment 4 and/or while cooling the interior of the left compartment 6. In this embodiment, the control device cools the interior of the left compartment 6 before cooling the interior of the right compartment 4. This is because the capacity of the left compartment 6 is smaller than that of the right compartment 4, and thus it is expected that the internal temperature of the left compartment 6 will exceed the upper limit of the first preset temperature before the internal temperature of the right compartment 4 does.

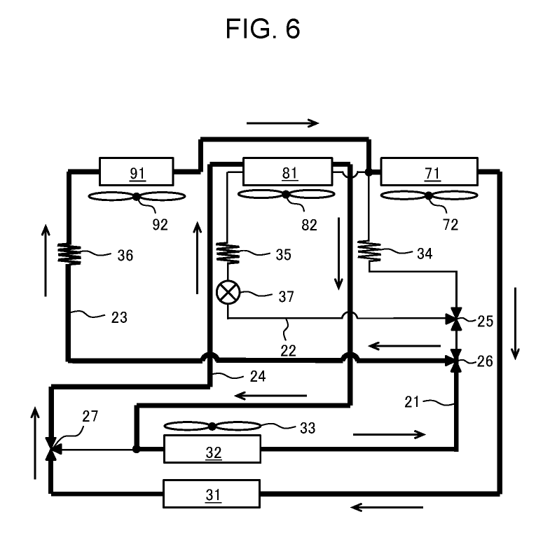

When the internal temperature of the left compartment 6 exceeds the upper limit of the first preset temperature after the defrosting of the first and third evaporators 71, 91 is finished, the control device activates the compressor 31, the gas cooler fan 33, and the first and third evaporator fans 72, 92, and turns on the second and third flow channel switching valves 26, 27. As a result, the refrigerant circulates by way of the compressor 31, the second evaporator 81, the gas cooler 32, the third capillary tube 36, the third evaporator 91, and the first evaporator 71 sequentially in this order, as shown in FIG. 6. This means that the high-temperature, high-pressure refrigerant gas (hot gas) discharged from the compressor 31 flows through the second evaporator 81, thus defrosting the second evaporator 81. In other words, the control device removes frost formed in the second evaporator 81 by using the hot gas. During the defrost control for the second evaporator 81, the refrigerant having passed through the second evaporator 81 then flows through the gas cooler 32, the third capillary tube 36, the third evaporator 91, and the first evaporator 71. This reduces the internal temperature(s) of the left compartment 6 (and the right compartment 4). In this event, however, only the internal temperature of the left compartment 6 may alternatively be reduced by stopping the first evaporator fan 72.

When the internal temperature of the left compartment 6 has been reduced to the lower limit of the first preset temperature, the control device finishes cooling the left compartment 6. When the temperature at the refrigerant outlet of the second evaporator 81 reaches a predetermined temperature (defrost finish temperature), the control device finishes defrosting the second evaporator 81. Below, description will be given individually for: (a) when the defrosting of the second evaporator 81 is finished before the cooling of the interior of the left compartment 6 is finished; (b) when the cooling of the interior of the left compartment 6 is finished before the defrosting of the second evaporator 81 is finished.
(a) When the defrosting of the second evaporator 81 is finished before the cooling of the interior of the left compartment 6 is finished

When the temperature at the refrigerant outlet of the second evaporator 81 reaches the defrost finish temperature before the internal temperature of the left compartment 6 has been reduced to the lower limit of the first preset temperature, the control device turns off the third flow channel switching valve 27. As a result, the refrigerant circulates by way of the compressor 31, the gas cooler 32, the third capillary tube 36, the third evaporator 91, and the first evaporator 71 sequentially in this order (see FIG. 3). In other words, the refrigerant (the hot gas) no longer flows through the second evaporator 81 during circulation. Accordingly, the defrosting of the second evaporator 81 is finished while the cooling of the left compartment 6 (and the right compartment 4) continues.

When the internal temperature of the left compartment 6 has been reduced to the lower limit of the first preset temperature, the control device stops the compressor 31, the gas cooler fan 33, and the first and third evaporator fans 72, 92, and turns off the second flow channel switching valve 26. Accordingly, the cooling of the interior of the left compartment 6 is finished, and the refrigeration cycle system 30 goes back to standby.

After that, when the internal temperature of the right compartment 4 exceeds the upper limit of the first preset temperature, the control device cools the interior of the right compartment 4. In other words, the control device activates the compressor 31, the gas cooler fan 33, and the first evaporator fan 72. In this event, the third flow channel switching valve 27 remains turned off since the defrosting of the second evaporator 81 has already finished. As a result, the refrigerant flows (circulates) through the first refrigerant flow channel 21 so as to reduce the internal temperature of the right compartment 4 (see FIG. 5).

Then, when the internal temperature of the right compartment 4 has been reduced to the lower limit of the first preset temperature, the control device stops the compressor 31, the gas cooler fan 33, and the first evaporator fan 72. As a result, the cooling of the interior of the right compartment 4 is finished, and the refrigeration cycle system 30 goes back to standby.

Assume here that the internal temperature of the right compartment 4 exceeds the upper limit of the first preset temperature while the interior of the left compartment 6 is cooled. In such case, after finishing cooling the interior of the left compartment 6, the control device causes the refrigeration cycle system 30 to immediately shift to cooling the interior of the right compartment 4 instead of switching the refrigeration cycle system 30 to standby. In other words, when the internal temperature of the left compartment 6 has been reduced to the lower limit of the first preset temperature, the control device stops the third evaporator fan 92 and turns off the second flow channel switching valve 26 so that the refrigeration cycle system 30 shifts to the cooling of the interior of the right compartment 4.
(b) When the cooling of the interior of the left compartment 6 is finished before the defrosting of the second evaporator 81 is finished

When the internal temperature of the left compartment 6 has been reduced to the lower limit of the first preset temperature before the temperature at the refrigerant outlet of the second evaporator 81 reaches the defrost finish temperature, the control device stops the compressor 31, the gas cooler fan 33, and the first and third evaporator fans 72, 92, and turns off the second and third flow channel switching valves 26, 27. As a result, the cooling of the interior of the left compartment 6 is finished, and the refrigeration cycle system 30 goes back to standby (while the defrosting of the second evaporator 81 has not been finished yet).

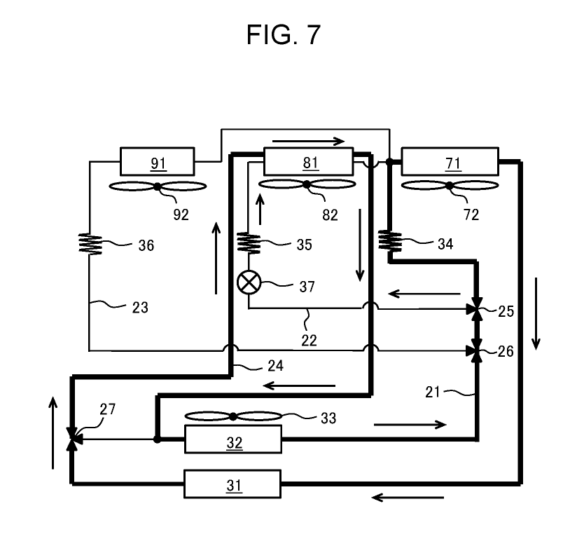

After that, when the internal temperature of the right compartment 4 exceeds the upper limit of the first preset temperature, the control device cools the interior of the right compartment 4 while defrosting the second evaporator 81. Specifically, the control device activates the compressor 31, the gas cooler fan 33, and the first evaporator fan 72, and turns on the third flow channel switching valve 27. As a result, the refrigerant circulates by way of the compressor 31, the second evaporator 81, the gas cooler 32, the first capillary tube 34, and the first evaporator 71 sequentially in this order, as shown in FIG. 7. This means that the refrigerant (hot gas) discharged from the compressor 31 flows through the second evaporator 81, thus defrosting the second evaporator 81 (using the hot gas). Also, the refrigerant having passed through the second evaporator 81 then flows through the gas cooler 32, the first capillary tube 34, and the first evaporator 71. This reduces the internal temperature of the right compartment 4.

In this embodiment, the defrosting of the second evaporator 81 has already started during the cooling of the interior of the left compartment 6. Thus, normally, the temperature at the refrigerant outlet of the second evaporator 81 reaches the defrost finish temperature before the internal temperature of the right compartment 4 has been reduced to the lower limit of the first preset temperature. Accordingly, in such case, the control device controls the operation of the refrigeration cycle system 30 as follows.

The control device turns off the third flow channel switching valve 27 when the temperature at the refrigerant outlet of the second evaporator 81 reaches the defrost finish temperature. As a result, the refrigerant circulates through the first refrigerant flow channel 21 (see FIG. 5). In other words, the refrigerant (the hot gas) no longer flows through the second evaporator 81 during circulation. Accordingly, the defrosting of the second evaporator 81 is finished while the cooling of the right compartment 4 continues.

After that, when the internal temperature of the right compartment 4 has been reduced to the lower limit of the first preset temperature, the control device stops the compressor 31, the gas cooler fan 33, and the first evaporator fan 72. As a result, the cooling of the interior of the right compartment 4 is finished, and the refrigeration cycle system 30 goes back to standby.

In the defrost control described above, the third flow channel switching valve 27 becomes turned off when the cooling of the interior of the left compartment 6 is finished. Alternatively, however, the third flow channel switching valve 27 may remain turned on so that the defrosting of the second evaporator 81 still continue even during the cooling of the interior of the right compartment 4. This is because the defrosting of the second evaporator 81 is not finished yet when the cooling of the interior of the left compartment 6 becomes finished. In such case, the control device has only to activate the compressor 31, the gas cooler fan 33, and the first evaporator fan 72 when start cooling the interior of the right compartment 4 and defrosting the second evaporator 81 (no need to turn on the third flow channel switching valve 27). If the internal temperature of the right compartment 4 has been reduced to the lower limit of the first preset temperature before the temperature at the refrigerant outlet of the second evaporator 81 reaches the defrost finish temperature, the control device finishes cooling the interior of the right compartment 4 and switches the refrigeration cycle system 30 to standby. After that, the control device may resume and continue the defrosting of the second evaporator 81 while cooling of the interior of the left compartment 6.

According to the embodiment described above, the vending machine 1 has the right, center and left compartments 4, 5, 6 which are defined by the partition walls 3 and which are for cooling the bottled beverages contained therein. The right, center and left compartments 4, 5, 6 are disposed side by side in a row in the width direction of the vending machine 1 in the vending machine 1. The internal temperature of the center compartment 5, which lies between the right and left compartments 4, 6, is set lower than the internal temperatures of the right and left compartments 4, 6. Such structure allows less heat to enter the center compartment 5, whose internal temperature is set lower, from the outside. Thus, the structure allows for limiting energy (power consumption) required for cooling the interior of the center compartment 5.

In this embodiment, each of the right and left compartments 4, 6 functions as a refrigerator compartment, and the center compartment 5 functions as a supercooling compartment. In other words, the right and left compartments 4, 6 contain bottled beverages at a cool temperature suitable for drinking (>0° C.) to preserve the bottled beverages without freezing. The center compartment 5 contains bottled beverages in a supercooled state. Such structure makes it possible to simultaneously dispense bottled beverages cooled at different temperatures: refrigerated bottled beverages, which are cooled at a temperature suitable for drinking; and supercooled bottled beverages, while limiting energy required for cooling the interior of the center compartment 5.

In this embodiment, the vending machine 1 includes the refrigeration cycle system 30 as a cooling device capable of individually cooling the interiors of the right, center and left compartments 4, 5, 6. When starting up the vending machine 1, the internal temperatures of the right, center and left compartments 4, 5, 6 are first reduced to the first preset temperature, and the internal temperature of the center compartment 5 is then further reduced to the second preset temperature. In other words, after sufficiently reducing the internal temperatures of the right and left compartments 4, 6, (the control device of) the vending machine 1 further reduces the internal temperature of the center compartment 5 to the second preset temperature (<the first preset temperature). Such stepwise approach makes it possible to limit energy required for cooling the interior of the center compartment 5 as compared to reducing the internal temperature of the center compartment 5 to the second preset temperature in one go. Furthermore, it is possible to sell bottled beverages in the right and left compartments 4, 6 (i.e., in the refrigerator compartments) before the bottled beverages in the center compartment 5 (i.e., in the supercooling compartment) become ready to sell, thus reducing the loss of sales opportunities.

Furthermore, in this embodiment, (the control device of) the vending machine 1 removes frost formed in the first and third evaporators (in-compartment heat exchangers) 71, 91 disposed in the right and left compartments 4, 6 by blowing in-compartment air to the first and third evaporators 71, 91, respectively. On the other hand, (the control device of) the vending machine 1 removes frost formed in the second evaporator (in-compartment heat exchanger) 81 by using the high-temperature, high-pressure refrigerant gas (hot gas) discharged from the compressor 31. The defrosting of the first and third evaporators 71, 91 is finished when a preset defrost time has elapsed, and the defrosting of the second evaporator 81 is finished when the temperature at the refrigerant outlet of the second evaporator 81 reaches a predetermined temperature. This makes it possible to reliably defrost the second evaporator 81 disposed in the center compartment 5 whose internal temperature is 0° C. or less while limiting energy required for defrosting the evaporators 71, 81, 91.

In particular, in this embodiment, after the defrosting of the first and third evaporators 71, 91 is finished, the second evaporator 81 is defrosted simultaneously with the cooling of the interior of the right compartment 4 or the left compartment 6. Thus, the first to third evaporators 71, 81, 91 can be defrosted at approximately the same time, which ensures that the vending machine 1 continues to reliably operate. Normally, it is necessary to cool the interior of the right compartment 4 after finishing defrosting the first evaporator 71, and to cool the interior of the left compartment 6 after finishing defrosting the third evaporator 91. Thus, the defrosting method according to this embodiment eliminates the additional need for causing the refrigeration cycle system 30 to operate only for defrosting the second evaporator 81, and thus makes it possible to reduce energy consumption (power consumption) in total.

In the above embodiment, the vending machine 1 has three compartments (the right, center and left compartments 4, 5, 6) for cooling the bottled beverages as products for sale, and causes each of the right and left compartments 4, 6 to function as a refrigerator compartment, and the center compartment 5 to function as a supercooling compartment. However, the present invention is not limited to this. The products sold in the vending machine 1 do not have to be the bottled beverages. Furthermore, the internal temperature of the center compartment 5 has only to be lower than the internal temperatures of the right and left compartments 4, 6. For example, the center compartment 5 may function as a freezer compartment. Further, a still alternative configuration may be employed in which at least either of the right and left compartments 4, 6 functions as a supercooling compartment while the center compartment 5 functions as a freezer compartment.

Moreover, the vending machine 1 may have four or more compartments which are disposed side by side in a row and which are for cooling products contained therein. In such case, the internal temperature of each of the in-between compartments other than the two side compartments each located at either end is set lower than the internal temperature of the two side compartments. Needless to say, the “compartment for cooling products contained therein” used herein indicates not only a cooling-only compartment only for cooling the products contained therein, but also a compartment both for cooling and heating the products by switching therebetween.

In the above embodiment, (the control device of) the vending machine 1 first reduces the internal temperatures of the right, center and left compartments 4, 5, 6 to the first preset temperature, and then further reduces the internal temperature of the center compartment 5 to the second preset temperature. However, the present invention is not limited to this. It is only necessary to reduce the internal temperature of the center compartment 5 to the second preset temperature at least under the conditions in which the internal temperatures of the right and left compartments 4, 6 has been already reduced to the first preset temperature. For example, (the control device of) the vending machine 1 may cool the center compartment 5 to reduce the internal temperature of the center compartment 5 to the second preset temperature after reducing the internal temperatures of the right and left compartments 4, 6 to the first preset temperature. Moreover, the preset internal temperature for the right compartment 4 may be different from the preset internal temperature for the left compartment 6. In such case, the internal temperature of the center compartment 5 may be reduced to the second preset temperature, which is the preset internal temperature for the center compartment 5, after the internal temperatures of the right and left compartments 4, 6 are reduced to their preset internal temperatures. Needless to say, the internal temperature of the center compartment 5 may be first reduced to either the preset internal temperature for the right compartment 4 or the preset internal temperature for the left compartment 6, and then further reduced to the second preset temperature. Similar alterations may be applied to the vending machine 1 having four or more compartments each for cooling products contained therein. Note, however, that in light of limiting energy required for cooling the interiors of the compartments, it is preferable to first reduce the internal temperatures of all the compartments (the right, center and left compartments 4, 5, 6) to approximately the same temperature, then further reduce the internal temperatures of the in-between compartments (the center compartment 5).

In the above embodiment, the control device sequentially reduces the internal temperatures of the compartments 4 to 6 to the first preset temperature. However, the present invention is not limited to this. Alternatively, the control device may repeat a process of sequentially reducing the internal temperatures of the compartments 4 to 6 by a small amount (by 2° C. to 5° C., for example) such that the internal temperatures of the compartments 4 to 6 reach the first preset temperature at approximately the same time. This allows the internal temperatures of all the compartments 4 to 6 to reduce in approximately the same manner, and thus makes it possible to sell the bottled beverages in all the compartments 4 to 6 in somewhat cool conditions even during, for example, the start-up control described above.

In the above embodiment, the first and third evaporators 71, 91 are defrosted simultaneously. However, the first and third evaporators 71, 91 may be defrosted at different timings from each other. In such case, the second evaporator 81 may be defrosted while the interior of the right compartment 4 is cooled after the defrosting of the first evaporator 71 is finished and/or while the interior of the left compartment 6 is cooled after the defrosting of the third evaporator 91 is finished.

In the above embodiment, (the control device of) the vending machine 1 cools the interior of the right compartment 4 when the internal temperature of the right compartment 4 exceeds the upper limit of the first preset temperature after the defrosting of the first evaporator 71 is finished, and cools the interior of the left compartment 6 when the internal temperature of the left compartment 6 exceeds the upper limit of the first preset temperature after the defrosting of the third evaporator 91 is finished. However, the present invention is not limited to this. Alternatively, (the control device of) the vending machine 1 may cool the interior of the right compartment 4 immediately after finishing defrosting the first evaporator 71; in other words, without checking the internal temperature of the right compartment 4. Similarly, (the control device of) the vending machine 1 may cool the interior of the left compartment 6 immediately after finishing defrosting the third evaporator 91; in other words, without checking the internal temperature of the left compartment 6.

In the above embodiment, the defrosting of the second evaporator 81 continues until the temperature at the refrigerant outlet of the second evaporator 81 reaches the defrost finish temperature. However, the present invention is not limited to this. Alternatively, the defrosting of the second evaporator 81 may continue until a predetermined time has elapsed after the temperature at the refrigerant outlet of the second evaporator 81 reaches the defrost finish temperature. This ensures more reliable defrosting of the second evaporator 81.

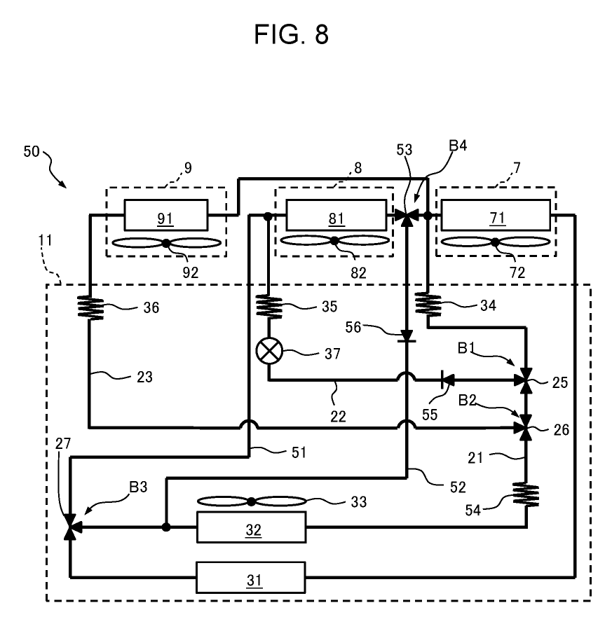

Furthermore, the vending machine 1 may include, for example, a refrigeration cycle system 50 shown in FIG. 8 in place of the refrigeration cycle system 30 (FIG. 2). Note that, in FIG. 8, identical components are given the same numerals as in FIG. 2. The refrigeration cycle system 30 (FIG. 2) is different from the refrigeration cycle system 50 shown in FIG. 8 in the following respects.

The first difference is that the refrigeration cycle system 50 (FIG. 8) includes a fifth refrigerant flow channel 51 and a sixth refrigerant flow channel 52 in place of the fourth refrigerant flow channel 24 of the refrigeration cycle system 30 (FIG. 2). The fifth refrigerant flow channel 51, which branches off from the first refrigerant flow channel 21 at the predetermined point (the branching point B3) between the compressor 31 and the gas cooler 32, is connected to the second refrigerant flow channel 22 at a point close to the inlet of the second evaporator 81. The sixth refrigerant flow channel 52, which branches off from the second refrigerant flow channel 22 at a point close to the outlet of the second evaporator 81, is connected to the first refrigerant flow channel 21 at a point between the branching point B3 and the gas cooler 32. A fourth flow channel switching valve (electromagnetic three-way valve) 53 is provided at the branching point B4 where the sixth refrigerant flow channel 52 branches off from the second refrigerant flow channel 22. When turned off, the fourth flow channel switching valve 53 permits communication between the first refrigerant flow channel 21 and the second evaporator 81 through the second refrigerant flow channel 22 with respect to the branching point B4. When turned on, the fourth flow channel switching valve 53 permits communication between the sixth refrigerant flow channel 52 and the second evaporator 81 through the second refrigerant flow channel 22 with respect to the branching point B4. The control device turns on the fourth flow channel switching valve 53 to defrost the second evaporator 81.

The second difference is that the refrigeration cycle system 50 (FIG. 8) includes a fourth capillary tube 54 provided in the first refrigerant flow channel 21 at a point between the gas cooler 32 and the second flow channel switching valve 26 (between the internal heat exchanger and the second flow channel switching valve 26 if the refrigeration cycle system 50 includes the internal heat exchanger). It is preferable to provide a check valve 55 between the first flow channel switching valve 25 and the electronic expansion valve 37 so as to ensure reliable operation of the first flow channel switching valve 25. Also, it is preferable to provide a check valve 56 between the fourth flow channel switching valve 53 and the gas cooler 32 (in other words, provide a check valve 56 in the sixth refrigerant flow channel 52) so as to ensure reliable operation of the fourth flow channel switching valve 53. The control performed by the control device in the refrigeration cycle system 50 is basically the same as that in the refrigeration cycle system 30 (FIG. 2) except for turning on the fourth flow channel switching valve 53 to defrost the second evaporator 81.

The embodiment and its modifications according to the present invention have been described above. However, the present invention is not limited to the embodiment and the modifications described above, but, as a matter of course, further modifications and alterations may be made based on the technical concept of the present invention.

### REFERENCE SYMBOL LIST

1 vending machine
2 product storage
3 heat-insulated wall (partition wall)
4 right compartment
5 center compartment
6 left compartment
7 first cooling unit
8 second cooling unit
9 third cooling unit
10 machine compartment
11 condensing unit
20 refrigerant pipe
21 to 24 first to fourth refrigerant flow channels
25 to 27 first to third flow channel switching valves
30 refrigeration cycle system (cooling device)
31 compressor
32 gas cooler (external-to-compartment heat exchanger)
33 gas cooler fan
34 to 36 first to third capillary tubes (expansion mechanisms)
37 electronic expansion valve (expansion mechanism)
50 refrigeration cycle system (cooling device)
51 fifth refrigerant flow channel
52 sixth refrigerant flow channel
53 fourth flow channel switching valve
54 fourth capillary tube
71 first evaporator (in-compartment heat exchanger)
72 first evaporator fan
81 second evaporator (in-compartment heat exchanger)
82 second evaporator fan
91 third evaporator (in-compartment heat exchanger)
92 third evaporator fan

1. A vending machine having at least three compartments which are defined by partition walls and which are for cooling products therein, wherein
the at least three compartments are disposed side by side in a row, and
the at least three compartments include a first compartment and a second compartment, and a remaining compartment which is other than and disposed between the first and second compartments in which a preset internal temperature for the remaining compartment is lower than preset internal temperatures for the first and second compartments.

2. The vending machine according to claim 1, wherein
the products are bottled beverages, and
the preset internal temperatures for the first and second compartments are higher than the freezing point of the bottled beverages, and the preset internal temperature for the remaining compartment is equal to or lower than the freezing point of the bottled beverages.

3. The vending machine according to claim 1, wherein
the products are bottled beverages, and
each of the first and second compartments maintains the bottled beverages cool under refrigeration, and the remaining compartment maintains bottled beverages in a supercooled state.

4. The vending machine according to claim 1, wherein the preset internal temperatures for the first and second compartments are higher than 0° C., and the preset internal temperature of the remaining compartment is around −5° C.

5. The vending machine according to claim 1, comprising a cooling device capable of individually cooling interiors of the at least three compartments,
wherein the cooling device first reduces internal temperatures of all the at least three compartments to a preset internal temperature for the first and second compartments, and then further reduces an internal temperature of the remaining compartment to the preset internal temperature for the remaining compartment.

6. The vending machine according to claim 1, comprising a cooling device capable of individually cooling interiors of the at least three compartments,
wherein, when starting up the vending machine, the cooling device first reduces internal temperatures of the first and second compartments respectively to the preset internal temperatures for the first and second compartments, and then reduces an internal temperature of the remaining compartment to the preset internal temperature for the remaining compartment.

7. The vending machine according to claim 5, wherein
the cooling device includes: a compressor for compressing refrigerant; a gas cooler for cooling the refrigerant; an expansion mechanism for expanding the refrigerant; and in-compartment heat exchangers disposed respectively in the at least three compartments, and
the cooling device individually cools the at least three compartments by circulating the refrigerant by way of selectively any or all of the in-compartment heat exchangers.

8. The vending machine according to claim 7, wherein
the cooling device further includes a refrigerant flow channel for allowing high-temperature, high-pressure refrigerant gas discharged from the compressor to flow through the in-compartment heat exchanger disposed in the remaining compartment, and
the cooling device defrosts the in-compartment heat exchanger disposed in the remaining compartment by causing the high-temperature, high-pressure refrigerant gas discharged from the compressor to flow through the in-compartment heat exchanger disposed in the remaining compartment.

9. The vending machine according to claim 8, wherein the in-compartment heat exchanger disposed in the remaining compartment is defrosted simultaneously with the cooling of the interior of the first compartment or the second compartment.

10. The vending machine according to claim 9, wherein the in-compartment heat exchanger disposed in the remaining compartment is defrosted after the defrosting of the in-compartment heat exchanger disposed in at least either of the first and second compartments is finished.

11. The vending machine according to claim 8, wherein the defrosting of the in-compartment heat exchanger disposed in the remaining compartment continues until a temperature at a refrigerant outlet of the in-compartment heat exchanger reaches a predetermined temperature.

12. The vending machine according to claim 8, wherein the defrosting of the in-compartment heat exchanger disposed in the remaining compartment continues until a predetermined time has elapsed after a temperature at a refrigerant outlet of the in-compartment heat exchanger reaches a predetermined temperature.

13. The vending machine according to claim 2, wherein
the products are bottled beverages, and
each of the first and second compartments maintains the bottled beverages cool under refrigeration, and the remaining compartment maintains bottled beverages in a supercooled state.

14. The vending machine according to claim 2, wherein the preset internal temperatures for the first and second compartments are higher than 0° C., and the preset internal temperature of the remaining compartment is around −5° C.

15. The vending machine according to claim 3, wherein the preset internal temperatures for the first and second compartments are higher than 0° C., and the preset internal temperature of the remaining compartment is around −5° C.

16. The vending machine according to claim 4, comprising a cooling device capable of individually cooling interiors of the at least three compartments,
wherein the cooling device first reduces internal temperatures of all the at least three compartments to a preset internal temperature for the first and second compartments, and then further reduces an internal temperature of the remaining compartment to the preset internal temperature for the remaining compartment.

17. The vending machine according to claim 3, comprising a cooling device capable of individually cooling interiors of the at least three compartments,
wherein, when starting up the vending machine, the cooling device first reduces internal temperatures of the first and second compartments respectively to the preset internal temperatures for the first and second compartments, and then reduces an internal temperature of the remaining compartment to the preset internal temperature for the remaining compartment.

18. The vending machine according to claim 6, wherein
the cooling device includes: a compressor for compressing refrigerant; a gas cooler for cooling the refrigerant; an expansion mechanism for expanding the refrigerant; and in-compartment heat exchangers disposed respectively in the at least three compartments, and
the cooling device individually cools the at least three compartments by circulating the refrigerant by way of selectively any or all of the in-compartment heat exchangers.

19. The vending machine according to claim 9, wherein the defrosting of the in-compartment heat exchanger disposed in the remaining compartment continues until a temperature at a refrigerant outlet of the in-compartment heat exchanger reaches a predetermined temperature.

20. The vending machine according to claim 10, wherein the defrosting of the in-compartment heat exchanger disposed in the remaining compartment continues until a predetermined time has elapsed after a temperature at a refrigerant outlet of the in-compartment heat exchanger reaches a predetermined temperature.
